(19) United States
(12) Patent Application Publication
(10) Pub. No.: US 2012/0020395 A1
(43) Pub. Date: Jan. 26, 2012

(54) SYSTEM AND METHOD FOR DIGITAL SUBSCRIBER LOOP CROSSTALK CANCELLATION

(76) Inventors: Elad Domanovitz, Mazkeret Batya (IL); Eitan Tsur, Rishon LeZion (IL)

(21) Appl. No.: 13/140,824

(22) PCT Filed: Dec. 23, 2009
(86) PCT No.: PCT/US09/69481

§ 371 Date: Oct. 6, 2011

Related U.S. Application Data
(60) Provisional application No. 61/140,167, filed on Dec. 23, 2008.

(51) Int. Cl. H04B 1/38

(52) U.S. Cl. 375/222

(57) ABSTRACT

A system and a method for crosstalk cancellation, the method includes: (i) generating estimated crosstalk cancellation matrices for each frequency bin of a group of adjacent frequency bins, wherein each estimated crosstalk cancellation matrix provides an estimation of a crosstalk cancellation that is expected to mitigate crosstalk that is generated at a single frequency bin by an array of transmitters that transmit information over different copper pairs that form a bonded digital subscriber line link; (ii) generating a group crosstalk cancellation matrix based on the estimated crosstalk cancellation matrices, wherein a size of the group crosstalk cancellation matrix is smaller that an aggregate size of the estimated crosstalk cancellation matrices; and (iii) cancelling crosstalk for each frequency bin of the group by utilizing the group crosstalk cancellation matrix.

### CROSS REFERENCE TO RELATED APPLICATIONS

This application claims the benefit of U.S. Ser. No. 61/140,164, filed on Dec. 23, 2008 and entitled “Memory Optimization for DSL Crosstalk Cancellation Systems”, which is incorporated in its entirety herein by reference.

### BACKGROUND OF THE INVENTION

One of the most effective and efficient methods of deploying high-speed digital services to business and residential customers is to use one of the many forms of DSL (Digital Subscriber Loop) technologies over copper telephone wires. This approach has become very popular in the last 20 years due to the fact that copper wires are already deployed almost everywhere and are quite easy to access, both at the Central Office (CO) and at the Remote Terminal (RT) or the customer.

However, one of the main limitations of DSL technology is that the data capacity of copper wires decreases significantly as the length of the copper loop increases. Therefore, customers located more than a few kilometers from the Central Office can not be provided with high data speeds over copper wires.

One way to mitigate this issue is to use multiple copper pairs to the same customer location, thereby increasing the total data rate of the resulting multi-pair copper link. This method is typically referred to as “bonding” of copper pairs.

Another significant limitation of DSL technology is the significant spectral interference between DSL services deployed on different twisted copper pairs in the same cable. Spectral interference between different high-bitrate services in a copper cable is caused by the fact that each copper pair acts as an antenna. The signal transmitted on each copper pair, which is intended for the receiver located at the other end of that copper pair, is also inadvertently picked up by all of the neighboring copper pairs, because those pairs are not individually shielded from each other. This creates the well-known phenomenon of “crosstalk”, aptly named for the effect it caused in the early days of the telephone, when the telephone discussion taking place on one line could sometimes be overheard by the people conversing on a different line.

Due to the physical characteristics of copper pairs, and in particular due to the average length of the twist between the two copper wires making up each pair, the crosstalk coupling between different pairs increases exponentially with the frequency of the transmitted signal. But this crosstalk coupling is only one of the three factors that determine the strength of crosstalk; the other two are the strength of the disturbing transmitter (typically referred to as a “disturber”) and the sensitivity of the disturbed receiver (typically referred to as a “victim”) at any given frequency. For example, if the transmit frequency band of the disturber is different than the receive frequency band of the victim, then there will be almost no crosstalk.

Crosstalk typically consists of Near-End Crosstalk (NEXT), caused by disturbers located at the “near-end”, i.e., on the same side (network side or customer side) of the copper loop as the victim's receiver, and Far-End Crosstalk (FEXT), caused by disturbers located at the “far-end”, i.e., on the opposite side of the copper loop from the victim's receiver.

There are two approaches for modulating the data in DSL modems—Single carrier and multi carrier. In the last years multi carrier (typically referred to as a “Discrete Multi Tone” (DMT)) technology has become more and more popular and it is the technology that is going to be used for transferring high bit rates. DMT system s does not transmit a constant number of bits across the bandwidth. Instead DMT system partition the available bandwidth into a set of sub channels (typically referred to as “Frequency Bins”) and each bin supports different number of bits which is proportional to its SNR and the desired symbol error probability.

Since most of the DMT technologies (such as ADSL, ADSL 2+ and many VDSL profiles) use FDM (Frequency Division Multiplexing) in allocating the power between Upstream and Downstream it means that lines that carry VDSL2 services do not generate Self-FEXT to each other.

However, since VDSL is typically deployed on short loops, Self-FEXT is a significant concern. Self-FEXT can be eliminated between lines belonging to the same bonded link by building a matrix receiver that utilizes the crosstalk from other modems as part of the main received signal. Self-TEXT can also be cancelled between lines that do not belong to the same bonded link, even if the disturbing transmitters and victim receivers are only connected to the same DSL equipment on one side of the loop.

This means, for example, that Self-FEXT can be cancelled between DSL lines serving different customer locations, as long as they originate from the same DSL equipment on the CO-side of the loop. Self-FEXT cancellation is possible because the disturbing signals are available in the same location, either on the transmitter side for downstream signals, or on the receiver side for upstream signals.

Therefore, downstream Self-FEXT can be cancelled by pre-coding the transmitted signals with crosstalk-cancelling additional signals, and upstream Self-FEXT can be cancelled by decoding the received signals and subtracting the crosstalk effects of each of those received signals from the other received signals. FEXT Cancellation is typically referred to as a “Vectoring”. There are various prior art methods for learning the FEXT of the channel. Once the FEXT is learnt there is a need to cancel it. A simple way for FEXT cancellation is to perform linear pre-coding/decoding before the transmission (or after the receiving) of the data. The pre-coding/decoding process may require many memory accesses. Working on each bin separately requires storing pre-coding/decoding for each bin in a memory which might raise a problem. A more severe problem might rise from the need to read those matrices in a very high rate.

For example, assuming that an array of modems includes eight VDSL2 modems at sampling rate of 17 MHz and 16 complex bits (i.e., 32 total bits) per coefficient. This indicates that the coefficient matrix includes 8×8 coefficients (in order to take into account the affect of each modem on any modem of the seven other modes). This means that there is a need to store more than eight megabits of information over the entire 4096 frequency bins:

$$32 ( \frac{bits}{coeff} ) * 64 ( \frac{coeff}{matrix} ) * 4096 ( \frac{bins ( matrices )}{symbol} ) = 8.3886 Mbits$$

This information should be read at a rate of more than thirty gigabits per seoond:

$$32 ( \frac{bits}{coeff} ) * 64 ( \frac{coeff}{matrix} ) * 4096 ( \frac{bins ( matrices )}{symbol} ) * 4000 ( \frac{symbol}{sec} ) = 33.55 Gbps$$

### SUMMARY OF THE INVENTION

According to an embodiment of the invention a method for crosstalk cancellation is provided. The method includes: (i) generating estimated crosstalk cancellation matrices for each frequency bin of a group of adjacent frequency bins, wherein each estimated crosstalk cancellation matrix provides an estimation of a crosstalk cancellation that is expected to mitigate crosstalk that is generated at a single frequency bin by an array of transmitters that transmit information over different copper pairs that form a bonded digital subscriber line link; (ii) generating a group crosstalk cancellation matrix based on the estimated crosstalk cancellation matrices, wherein a size of the group crosstalk cancellation matrix is smaller that an aggregate size of the estimated crosstalk cancellation matrices; and (iii) cancelling crosstalk for each frequency bin of the group by utilizing the group crosstalk cancellation matrix.

According to an embodiment of the invention a method for crosstalk cancellation is provided. The method includes: (i) generating an estimated crosstalk cancellation matrix for a single frequency bin out of a group of adjacent frequency bins, wherein the estimated crosstalk cancellation matrix provides an estimation of a crosstalk cancellation that is expected to mitigate crosstalk that is generated at the single frequency bin by an array of transmitters that transmit information over different copper pairs that form a bonded digital subscriber line (DSL) link; and (ii) cancelling crosstalk for each frequency bin of the group by utilizing the estimated crosstalk cancellation matrix.

According to an embodiment of the invention a method for crosstalk cancellation is provided. The method includes: (i) generating a first estimated crosstalk cancellation matrix for a first frequency bin of a first group of adjacent frequency bins, wherein the first estimated crosstalk cancellation matrix provides an estimation of a crosstalk cancellation that is expected to mitigate crosstalk that is generated at the first frequency bin of the first group by an array of transmitters that transmit information over different copper pairs that form a bonded digital subscriber line (DSL) link; (ii) generating a second estimated crosstalk cancellation matrix for a first frequency bin of a second group of adjacent frequency bins, wherein the second estimated crosstalk cancellation matrix provides an estimation of a crosstalk cancellation that is expected to mitigate crosstalk that is generated at the first frequency bin of the second group by the array of transmitters; (iii) cancelling crosstalk for the first frequency bin of the first group by utilizing the first estimated crosstalk cancellation matrix; (iv) calculating additional crosstalk coefficients based on the first and second estimated crosstalk cancellation matrices; and (v) cancelling crosstalk for at least one other frequency bin of the first group that differs from the first frequency bin of the first group, by utilizing the additional crosstalk coefficients.

According to an embodiment of the invention a system for crosstalk cancellation is provided. The system includes: (i) a crosstalk estimator, for generating estimated crosstalk cancellation matrices for each frequency bin of a group of adjacent frequency bins; wherein each estimated crosstalk cancellation matrix provides an estimation of a crosstalk cancellation that is expected to mitigate crosstalk that is generated at a single frequency bin by an array of transmitters that transmit information over different copper pairs that form a bonded digital subscriber line (DSL) link; (ii) a generator, for generating a group crosstalk cancellation matrix based on the estimated crosstalk cancellation matrices, wherein a size of the group crosstalk cancellation matrix is smaller that an aggregate size of the estimated crosstalk cancellation matrices; and (iii) a crosstalk cancellation module for cancelling crosstalk for each frequency bin of the group by utilizing the group crosstalk cancellation matrix.

According to an embodiment of the invention a system for crosstalk cancellation is provided. The system includes: (i) a crosstalk estimator for generating an estimated crosstalk cancellation matrix for a single frequency bin out of a group of adjacent frequency bins; wherein the estimated crosstalk cancellation matrix provides an estimation of a crosstalk cancellation that is expected to mitigate crosstalk that is generated at the single frequency bin by an array of transmitters that transmit information over different copper pairs that form a bonded digital subscriber line (DSL) link; and (ii) a crosstalk cancellation module for cancelling crosstalk for each frequency bin of the group by utilizing the estimated crosstalk cancellation matrix.

According to an embodiment of the invention a system for crosstalk cancellation is provided. The system includes: (i) a first crosstalk estimator for generating a first estimated crosstalk cancellation matrix for a first frequency bin of a first group of adjacent frequency bins; wherein the first estimated crosstalk cancellation matrix provides an estimation of a crosstalk cancellation that is expected to mitigate crosstalk that is generated at the first frequency bin of the first group by an array of transmitters that transmit information over different copper pairs that form a bonded digital subscriber line (DSL) link; (ii) a second crosstalk estimator for generating a second estimated crosstalk cancellation matrix for a first frequency bin of a second group of adjacent frequency bins; wherein the second estimated crosstalk cancellation matrix provides an estimation of a crosstalk cancellation that is expected to mitigate crosstalk that is generated at the first frequency bin of the second group by the array of transmitters; (iii) a matrix based crosstalk cancellation module for cancelling crosstalk for the first frequency bin of the first group by utilizing the first estimated crosstalk cancellation matrix; (iv) a coefficient calculator for calculating additional crosstalk coefficients based on the first and second estimated crosstalk cancellation matrices; and (v) a calculation-based crosstalk cancellation module for cancelling crosstalk for at least one other frequency bin of the first group that differ from the first frequency bin of the first group by utilizing the additional crosstalk coefficients.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a first array of modems, a bonded link, a second array of modems, a crosstalk module and an information source/recipient according to an embodiment of the invention;

FIG. 2 schematically illustrates a method for crosstalk cancellation according to an embodiment of the invention;

FIG. 3 schematically illustrates a method for pre-coding according to an embodiment of the invention;

FIG. 4 schematically illustrates a method for crosstalk cancellation according to an embodiment of the invention;

FIG. 5 schematically illustrates a system for crosstalk cancellation according to an embodiment of the invention;

FIG. 6 schematically illustrates a method for crosstalk cancellation according to an embodiment of the invention;

FIG. 7 schematically illustrates a system for crosstalk cancellation according to an embodiment of the invention;

FIG. 8 schematically illustrates upstream bitrate changes introduced by the methods of FIGS. 2, 4 and 6 in comparison to prior art methods for crosstalk cancellation;

FIG. 9 schematically illustrates downstream bitrate changes introduced by the methods of FIGS. 2, 4 and 6 in comparison to prior art methods for crosstalk cancellation;

FIG. 10 illustrates a method for crosstalk cancellation according to an embodiment of the invention;

FIG. 11 illustrates a method for crosstalk cancellation according to an embodiment of the invention; and

FIG. 12 illustrates a method for crosstalk cancellation according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A first array of modems can transmit downstream information to a second array of modems. The first array of modems can perform FEXT cancellation by applying a pre-coding operation that precedes the transmission of the information. The pre-coding operation utilizes pre-coding matrices that include pre-coding coefficients.

The first array of modems can receive upstream information and perform FEXT cancellation by applying a decoding operation on the received upstream information. The decoding operation utilizes decoding matrices that include decoding coefficients.

For simplicity of explanation the phrase “pre-coding/decoding” refers to pre-coding as well as decoding.

It is noted that the methods and systems can apply only one of decoding and pre-coding, that the pre-coding and decoding are mutually independent and that the methods and devices illustrated below can pre-code in one manner and decode in another manner.

According to various embodiments of the invention various method for reducing the memory requirements of crosstalk (and especially FEXT) cancellation are provided. These methods can correlate either one of the pre-coding coefficients and decoding coefficients across different frequency bins. Conveniently, these methods can be applied mutatis mutandis to other types of crosstalk cancellation besides FEXT Cancellation, such as NEXT Cancellation.

Conveniently, estimated crosstalk cancellation matrices and crosstalk cancellation matrices (such as pre-coding matrices and decoding matrices) are “smooth” in the frequency domain—meaning that the differences in the values of the coefficients of adjacent frequency bins are relatively small. These differences can be, for example, approximated (for example—by interpolation) or can be ignored of.

According to an embodiment of the invention instead of using a separate pre-coding/decoding matrix for each frequency bin, the same matrix can be used for a group of frequency bins.

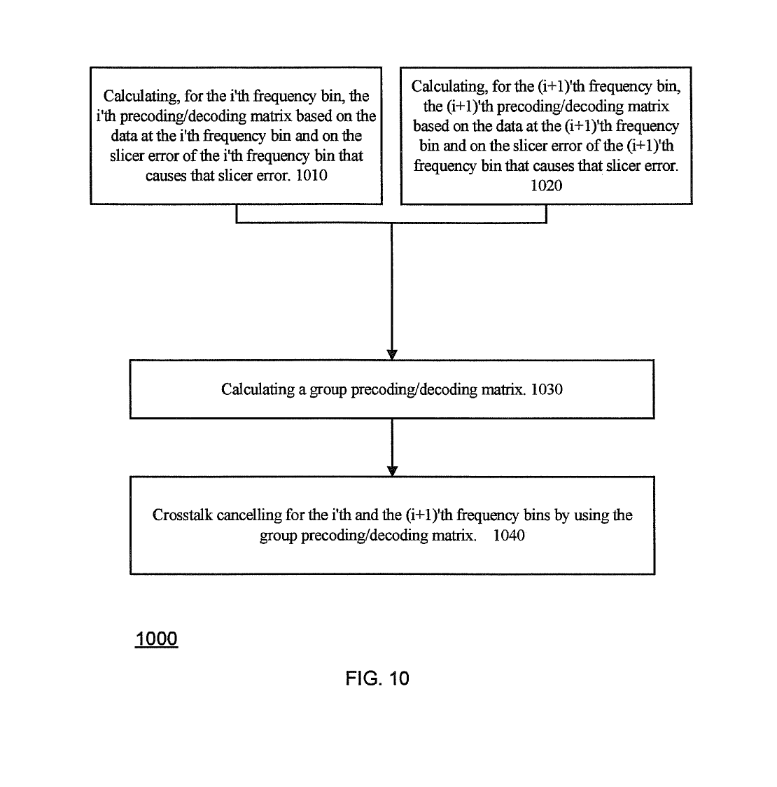

Some of the following figures (for example- FIGS. 10, 11 and 12) illustrate the proposed methods for the case where the same matrix is applied for each group of 2 consecutive bins (group size=2), and therefore the total number of pre-coding/decoding matrices is reduced by a factor of 2.

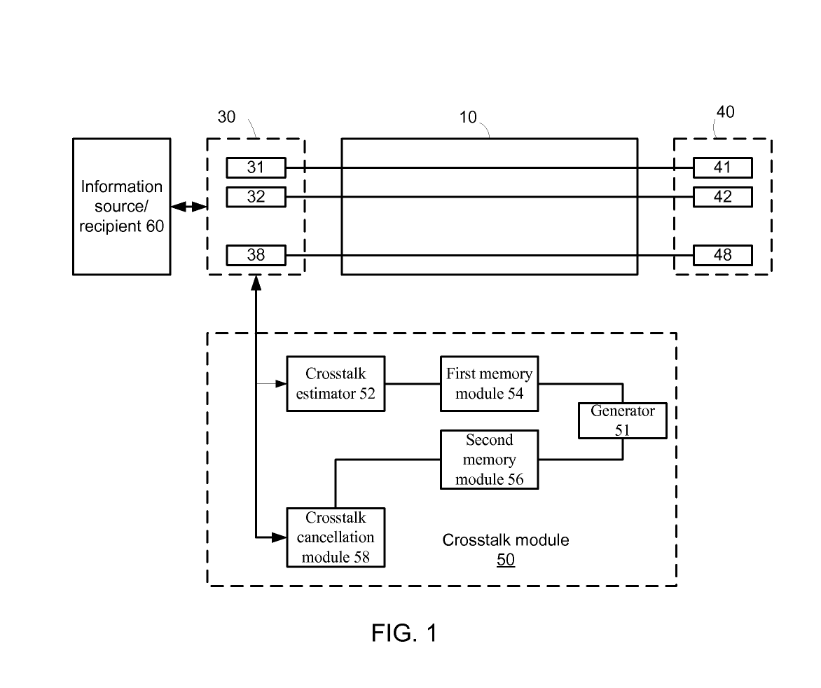

FIG. 1 illustrates a first array 30 of modems, a bonded DSL link 10, a second array 40 of modems, a crosstalk module 50 and an information source/recipient 60 according to an embodiment of the invention.

First array 30 of modems includes eight modems 31-38 and can transmit downstream information to the second array 40 of modems. The second array 40 includes eight modems 41-48. The term array is used to indicate that there is more than a single modem. The array can include more than eight modems or less than eight modems.

The first array 30 is connected to crosstalk module 50 and to information source/recipient 60. The upstream and downstream signal paths are independent. Each modem includes a transmitter and a receiver. The modems of a first array 30 are the “up” part of the “stream”, so their receivers receive upstream signals from the second array 40 and their transmitters transmit downstream signals to the second array 40.

Crosstalk cancellation can be applied on either one of the upstream and downstream directions or on both directions.

At a downstream direction information source/recipient 60 provides information to the first array 30. The first array 30 may process the information and then sends the information to the crosstalk module 50. The crosstalk module 50 performs crosstalk cancellation and provides pre-coded information to the first array 30. The first array 30 then further processes the pre-coded information (for example by performing Inverse FFT), sends the pre-coded information to its analog front end and transmits the pre-coded information over the bonded DSL link 10.

Conceptually the cancellation can be viewed as if at the downstream direction the crosstalk module 50 adds to each downstream transmitter signal an opposite of the estimated crosstalk contribution of all the other downstream signals (this way, when the signal arrives at the other end, the real crosstalk is essentially cancelled by the opposite of the estimated crosstalk, assuming that the estimated crosstalk is really close to the real crosstalk). Since this crosstalk cancellation operation happens before the information (signals) are being transmitted on the copper pairs this operation is called “pre-coding”.

At the upstream direction the bonded DSL link 10 provides information to the first array 30 (from the second array 40). The first array 30 may process the information (for example by performing a time to frequency conversion such as Fast Fourier Transform (FFT)) and then send the information to the crosstalk module 50. The crosstalk module 50 performs crosstalk cancellation and provides decoded information to the first array 30. The first array 30 then further processes the decoded information and sends the decoded information to information source/recipient 60.

Conceptually the cancellation can be viewed as if at the upstream direction the crosstalk module 50 cancels crosstalk by adding to each upstream received signal (of the received information) the opposite of the estimated crosstalk contribution of all the other upstream signals (this way, the real crosstalk is essentially cancelled by the opposite of the estimated crosstalk, assuming that the estimated crosstalk is really close to the real crosstalk).

Since this crosstalk cancellation operation happens after the signals have been transmitted on the copper pairs and received by the receivers, this operation is called “decoding”.

It is noted that the mentioned above crosstalk cancellation operations (pre-coding and decoding) are not related to each other. In other words, crosstalk module 50 can execute only one of the pre-coding and decoding or both.

The first array 30, crosstalk module 50 and information source/recipient 60 can belong to a central office while the second array 40 can regarded as a remote terminal.

FIG. 1 illustrates crosstalk module 50 as including generator 51, crosstalk estimator 52, first memory module 54, second memory module 56, and crosstalk cancellation module 58.

Crosstalk module 50 can be regarded as a system. Additionally or alternatively the system can also include the first array 30.

Crosstalk estimator 52 can generate one or more estimated crosstalk cancellation matrices for each group of adjacent frequency bins. The spectrum can include X (for example—4096) frequency bins. Crosstalk estimator 52 can generate Y estimated crosstalk cancellation matrices, and if there are n frequency bins per each group then Y can equal a ratio between X and n: Y=X/n.

The crosstalk estimator 52 can generate the estimated crosstalk cancellation matrices by processing information that was transmitted by modems of the first array 30 and by processing slicer errors (or other crosstalk indicators) that are sent from the modems of the second array 40.

The crosstalk estimator 52 can generate the estimated crosstalk cancellation matrices by processing information that was received by modems of the first array 30 and by processing slicer errors (or other crosstalk indicators) that are received from the modems of the first array 30.

Slicer errors are indicative of errors that were introduced during the transmission of the information by the first array 30 and during the reception of that information by the second array 40. A slicer error can indicate a difference between a received symbol and a matching symbol that belongs to the constellation of a modem of the second array 40 and of the first array 30. The generator 51 generates a group crosstalk cancelation matrix for each group of adjacent frequency bins, based on one or more estimated crosstalk cancellation matrices of that group.

Thus, the y′th group crosstalk cancelation matrix is based on n estimated crosstalk cancellation matrices of the n frequency bins of the y′th group.

The generator 51 can perform averaging, interpolation or apply any other process to generate each group crosstalk cancellation matrix.

First memory module 54 can store the estimated crosstalk cancellation matrices for each of the one or more groups of adjacent frequency bins.

Second memory module 56 can store the crosstalk cancellation matrix of each group of adjacent frequency bins.

Assuming that the size (number of coefficients per matrix) of the group crosstalk cancellation matrix equals the size of each of the estimated crosstalk cancellation matrices then the second memory module 56 stores only 1/n of the number of coefficients stored in the first memory module 54. The y′th group crosstalk cancellation matrix is used for the pre-coding/decoding operations of the y′th group of adjacent frequency bins that are numbered y*n, y*n+1, . . . , (y+1)*n−1.

For example, assuming that each of the first array and second array 40 includes 8 modems and that the size of each group of frequency bins is two—each group includes two frequency bins. In this case the size of the group crosstalk cancellation matrix is 64 and the size of each of the two estimated crosstalk cancellation matrices is 64. The aggregate size of the estimated crosstalk cancellation matrices is 128 (two matrices each including 64 coefficients) and the aggregate size of the estimated crosstalk cancellation matrices is larger than the size of the group crosstalk cancellation matrix.

The crosstalk cancellation module 58 can be a pre-coder or a decoder and can access the second memory module 56 to retrieve coefficients of the stored crosstalk cancellation matrices and cancel crosstalk.

### First Embodiment

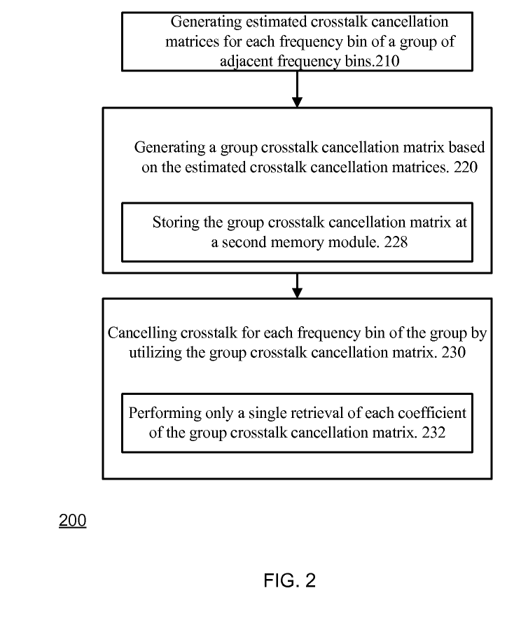

FIG. 2 illustrates method 200 for crosstalk cancellation, according to an embodiment of the invention.

Method 200 starts by stage 210 of generating estimated crosstalk cancellation matrices for each frequency bin of a group of adjacent frequency bins.

Each estimated crosstalk cancellation matrix provides an estimation of a crosstalk cancellation that is expected to mitigate crosstalk that is generated at a single frequency bin by an array of transmitters that transmit information over different copper pairs that form a bonded digital subscriber line link.

A k′th estimated crosstalk cancellation matrix can provide an estimation of the crosstalk generated at the k′th frequency bin.

Stage 210 is followed by stage 220 of generating a group crosstalk cancellation matrix based on the estimated crosstalk cancellation matrices.

The size of the group crosstalk cancellation matrix is smaller that an aggregate size of the estimated crosstalk cancellation matrices. The group crosstalk cancellation matrix can be of the same size of each of the estimated crosstalk cancellation matrices.

Stage 220 can include generating the group crosstalk cancellation matrix by averaging the estimated crosstalk cancellation matrices, by interpolating the estimated crosstalk cancellation matrices or by another process.

A single coefficient of the group crosstalk matrix can be calculated by processing the corresponding coefficients (for example—those which are located at the same location) of each of the estimated crosstalk cancellation matrices.

Stage 220 is followed by stage 230 of cancelling crosstalk for each frequency bin of the group by utilizing the group crosstalk cancellation matrix.

Method 200 can be applied for FEXT cancellation. In this case: (i) stage 210 can include generating estimated FEXT cancellation matrices for each frequency bin of the group, (ii) stage 220 can include generating a group FEXT cancellation matrix based on the estimated FEXT cancellation matrices, and (iii) stage 230 can include cancelling FEXT for each frequency bin of the group by utilizing the group FEXT cancellation matrix.

Stages 210, 220 and 230 can be applied for a single group of adjacent frequency bins but can also be applied on multiple groups of frequency bins. The groups can be of the same size (include the same number of frequency bins) or can differ from each other (include different numbers of frequency bins). The multiple groups of frequency bins usually form a spectrum of interest.

In this case, (i) stage 210 can include generating an estimated crosstalk cancellation matrix for each frequency bin of each group out of multiple groups of adjacent frequency bins, (ii) stage 220 can include generating, for each group, a group crosstalk cancellation matrix based on the estimated crosstalk cancellation matrices, and (iii) stage 230 can include cancelling crosstalk for each frequency bin of each group by utilizing a group crosstalk cancellation matrix of the group.

The estimated crosstalk cancellation matrices can be stored in a first memory module. These matrices can be updated by an update process that is slower (or at least occurs in a lower frequency) than the crosstalk cancellation of stages 230.

According to an embodiment of the invention method 200 can reduce the number of accesses required to obtain crosstalk cancellation coefficients by retrieving each coefficient only once from a second memory module during the crosstalk cancellation of the entire group of frequency bins.

Thus, stage 220 can include stage 228 of storing the group crosstalk cancellation matrix at a second memory module. Stage 230 may include stage 232 of performing only a single retrieval of each coefficient of the group crosstalk cancellation matrix.

The second memory module can have an access period that is shorter than the access period of the first memory module that stores the estimated crosstalk cancellation matrices. Method 200 can be applied for pre-coding, for decoding or for both. Method 300 illustrates a pre-coding sequence.

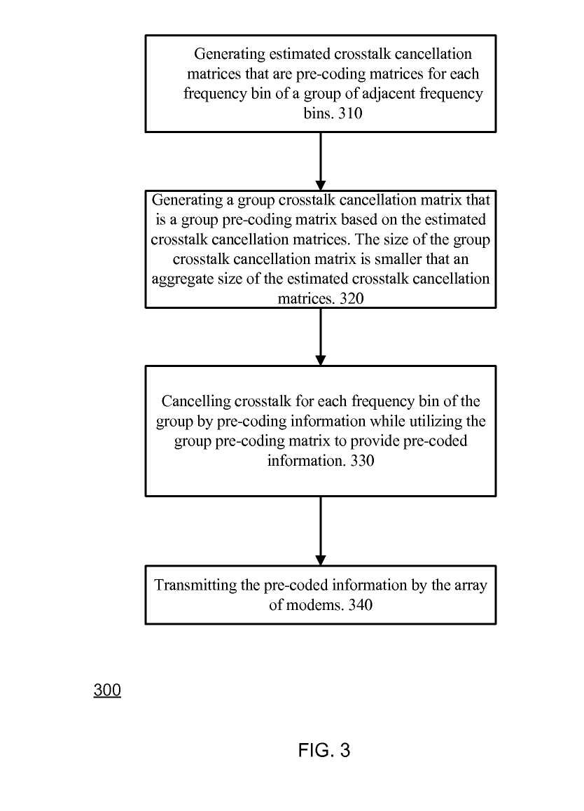

FIG. 3 illustrates a method 300 for pre-coding according to an embodiment of the invention.

Method 300 starts by stage 310 of generating estimated crosstalk cancellation matrices that are pre-coding matrices for each frequency bin of a group of adjacent frequency bins. Each estimated crosstalk cancellation matrix provides an estimation of a crosstalk cancellation that is expected to mitigate crosstalk that is generated at a single frequency bin by an array of transmitters that transmit information over different copper pairs that form a bonded digital subscriber line (DSL) link.

Stage 310 is followed by stage 320 of generating a group crosstalk cancellation matrix that is a group pre-coding matrix that is based on the estimated crosstalk cancellation matrices. The size of the group crosstalk cancellation matrix is smaller that an aggregate size of the estimated crosstalk cancellation matrices.

Stage 320 is followed by stage 330 of cancelling crosstalk for each frequency bin of the group by pre-coding information while utilizing the group pre-coding matrix to provide pre-coded information.

Stage 330 is followed by stage 340 of transmitting the pre-coded information by the array of modems.

Either one of method 200 and 300 can be executed by the crosstalk module 50 of FIG. 1.

Either one of method 200 and 300 can include retrieval of estimated crosstalk cancellation matrices from first memory module 54 and a retrieval of group crosstalk cancellation matrices from second memory module 56. The estimation can be executed at an estimation rate that is slower than the crosstalk cancellation rate. Accordingly, the first memory module 54 can be relatively slow in relation to the second memory module 56. The second memory module 56 should allow many accesses (for example 4000 accesses per second—an access per each DMT symbol) per second.

FIG. 10 illustrates method 1000 for crosstalk cancellation according to an embodiment of the invention.

It is assumed that each group includes two frequency bins. These frequency bins can be denoted as the i′th frequency bin and the (i+1)′th frequency bin.

Method 1000 starts by stages 1010 and 1020.

Stage 1010 includes calculating, for the i′th frequency bin, the i′th pre-coding/decoding matrix based on the data at the i′th frequency bin and on the slicer error of the i′th frequency bin that causes that slicer error.

Stage 1020 includes calculating, for the (i+1)′th frequency bin, the (i+1)′th pre-coding/decoding matrix based on the data at the (i+1)'th frequency bin and on the slicer error of the (i+1)′th frequency bin that causes that slicer error.

Stages 1010 and 1020 are followed by stage 1030 of calculating (for example by averaging) a group pre-coding/decoding matrix.

Stage 1030 is followed by stage 1040 of crosstalk cancelling for the i′th and the (i+1)′th frequency bins by using the group pre-coding/decoding matrix.

### Second Embodiment

According to the second embodiment only one set of coefficients is used for the estimation and for the pre-coding/decoding operations. A reduced set of coefficients is estimated and stored for each group of bins.

The estimation of the pre-coding/decoding coefficients is performed only for one bin in each group of n bins, and the resulting coefficients are used for the pre-coding/decoding operations on all the bins in the group.

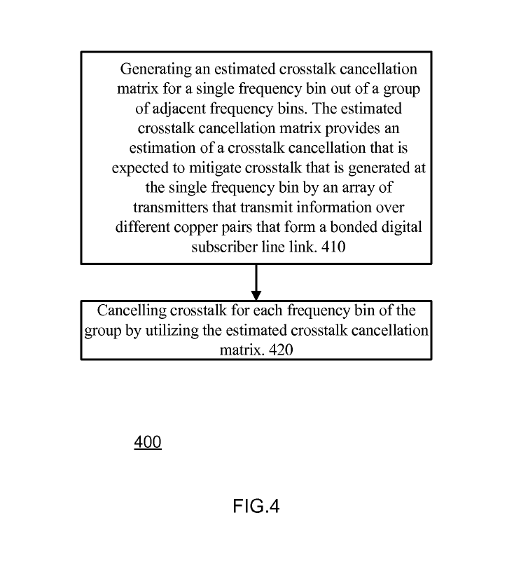

Therefore, only one memory module may be used for both estimation and pre-coding/decoding. FIG. 4 illustrates a method 400 for crosstalk cancellation, according to an embodiment of the invention.

Method 400 starts by stage 410 of generating an estimated crosstalk cancellation matrix for a single frequency bin out of a group of adjacent frequency bins. The estimated crosstalk cancellation matrix provides an estimation of a crosstalk cancellation that is expected to mitigate crosstalk that is generated at the single frequency bin by an array of transmitters that transmit information over different copper pairs that form a bonded digital subscriber line link.

Stage 410 is followed by stage 420 of cancelling crosstalk for each frequency bin of the group by utilizing the estimated crosstalk cancellation matrix.

Method 400 can be applied for FEXT cancellation. Accordingly, stage 410 can include generating an estimated FEXT cancellation matrix for the single frequency bin of the group, and stage 420 can include cancelling FEXT for each frequency bin of the group by utilizing the estimated FEXT cancellation matrix.

Stages 410 and 420 can be applied for a single group of adjacent frequency bins but can also be applied on multiple groups of frequency bins. The groups can be of the same size (include the same number of frequency bins) or can differ from each other (include different numbers of frequency bins).

Accordingly, stage 410 can includes generating, for each group out of multiple groups of adjacent frequency bins, an estimated crosstalk cancellation matrix. Stage 420 can include cancelling crosstalk for each frequency bin of each group by utilizing an estimated crosstalk cancellation matrix of the group.

Method 400 can be applied for pre-coding, for decoding or for both. Method 400 can use a single memory module out of first and second memory modules 54 and 56.

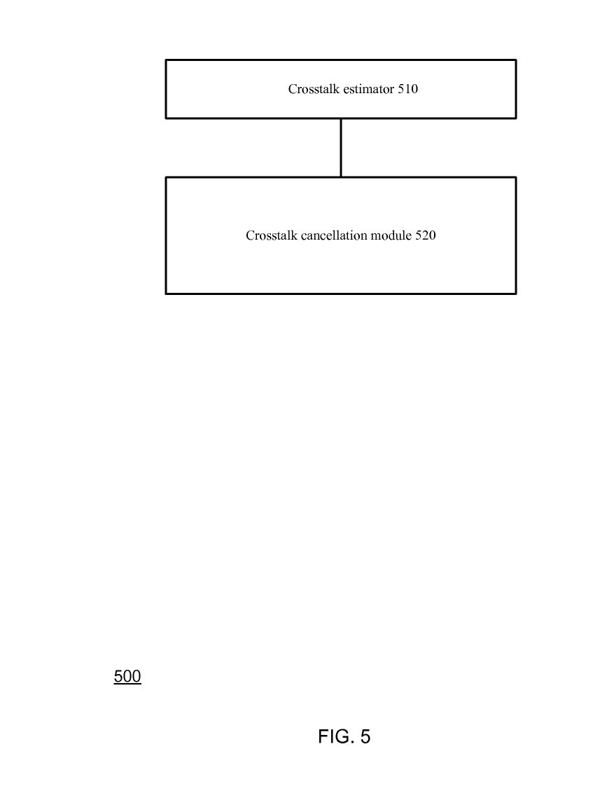

FIG. 5 illustrates system 500 for crosstalk cancellation, according to an embodiment of the invention.

System 500 can replace crosstalk module 50 of FIG. 1.

System 500 includes crosstalk estimator 510 and crosstalk cancellation module 520. It can also include, for example, a memory module (not shown) for storing one or more matrices.

The crosstalk estimator 510 is for generating an estimated crosstalk cancellation matrix for a single frequency bin out of a group of adjacent frequency bins. The estimated crosstalk cancellation matrix provides an estimation of a crosstalk cancellation that is expected to mitigate crosstalk that is generated at the single frequency bin by an array of transmitters that transmit information over different copper pairs that form a bonded digital subscriber line (DSL) link.

The crosstalk cancellation module 520 is for cancelling crosstalk for each frequency bin of the group by utilizing the estimated crosstalk cancellation matrix.

The crosstalk estimator 510 can be configured to generate estimated FEXT cancellation matrix for the single frequency bin of the group. The crosstalk cancellation module 520 can be configured to cancel FEXT for each frequency bin of the group by utilizing the estimated FEXT cancellation matrix.

Crosstalk estimator 510 can be configured to generate, for each group out of multiple groups of adjacent frequency bins, an estimated crosstalk cancellation matrix. The crosstalk cancellation module 520 can be configured to cancel crosstalk for each frequency bin of each group by utilizing an estimated crosstalk cancellation matrix that is associated with the group.

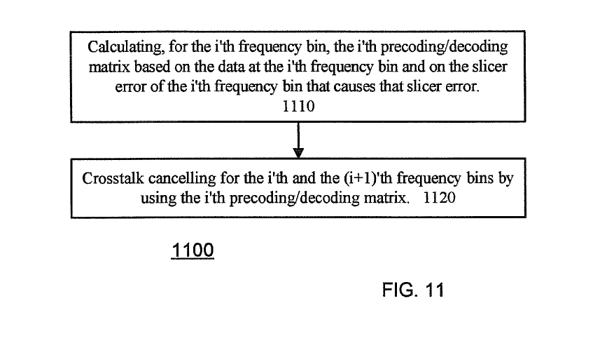

FIG. 11 illustrates method 1100 for crosstalk cancellation according to an embodiment of the invention.

It is assumed that each group includes two frequency bins. These can be denoted as the i′th frequency bin and the (i+1)′th frequency bin.

Method 1100 starts by stage 1110.

Stage 1110 includes calculating, for the i′th frequency bin, the i′th pre-coding/decoding matrix based on the data at the i′th frequency bin and on the slicer error of the i′th frequency bin that causes that slicer error.

Stage 1110 is followed by stage 1120 of crosstalk cancelling for each of the i′th and the (i+1)′th frequency bins by using the i′th pre-coding/decoding matrix.

### Third Embodiment

In this embodiment only one set of coefficients is used for the estimation and for the pre-coding/decoding operations itself. As in the previous embodiment, only one reduced set of coefficients is estimated and stored for each group of bins.

Estimation and adaptation of the pre-coding/decoding coefficients is performed only for one bin in each group of n bins.

The resulting coefficients are then used for pre-coding/decoding of that one bin in each group, while for the other bins in the group the coefficients are computed in real time using interpolation between the computed coefficients of their group and neighboring groups of bins.

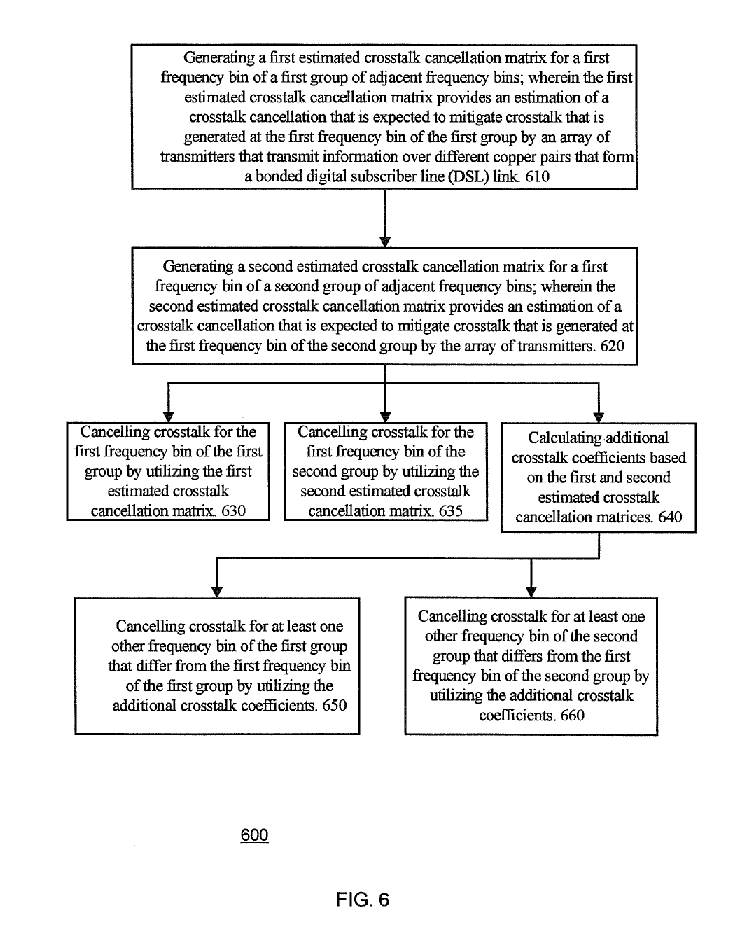

FIG. 6 illustrates method 600 for crosstalk cancellation, according to an embodiment of the invention.

Method 600 starts by stage 610 of generating a first estimated crosstalk cancellation matrix for a first frequency bin of a first group of adjacent frequency bins. The first estimated crosstalk cancellation matrix provides an estimation of a crosstalk cancellation that is expected to mitigate crosstalk that is generated at the first frequency bin of the first group by an array of transmitters that transmit information over different copper pairs that form a bonded digital subscriber line (DSL) link.

The first frequency bin can be the frequency bin that has the lowest frequency of the group of frequency bins, the lowest frequency of the group of frequency bins or any other intermediate frequency within the group of frequency bins.

Stage 610 is followed by stage 620 of generating a second estimated crosstalk cancellation matrix for a first frequency bin of a second group of adjacent frequency bins. The second estimated crosstalk cancellation matrix provides an estimation of a crosstalk cancellation that is expected to mitigate crosstalk that is generated at the first frequency bin of the second group by the array of transmitters.

Stage 620 is followed by stages 630, 635 and 640.

Stage 630 includes cancelling crosstalk for the first frequency bin of the first group by utilizing the first estimated crosstalk cancellation matrix.

Stage 635 includes cancelling crosstalk for the first frequency bin of the second group by utilizing the second estimated crosstalk cancellation matrix.

Stage 640 includes calculating additional crosstalk coefficients based on the first and second estimated crosstalk cancellation matrices. Stage 640 can also include calculating the additional coefficients based on other estimated crosstalk cancellation matrices.

Stage 640 is followed by stage 650 of cancelling crosstalk for at least one other frequency bin of the first group that differ from the first frequency bin of the first group by utilizing the additional crosstalk coefficients.

Stage 640 can also be followed by stage 660 of cancelling crosstalk for at least one other frequency bin of the second group that differs from the first frequency bin of the second group by utilizing the additional crosstalk coefficients. This other frequency bin can precede the first frequency bin of the second group.

For example, assuming that the second group includes three frequency bins and the first frequency bin of the second group (which is managed during stage 635) is the central frequency bin of the second group-it is preceded by so-called initial frequency bin and followed by a so-called terminal frequency bin. In this case stage 660 can include cancelling crosstalk form the initial frequency bin of the second group by using additional crosstalk coefficients that are calculated during stage 640.

Stage 630 can include cancelling crosstalk for the first frequency bin of the first group by retrieving the first estimated crosstalk cancellation matrix from a memory module and multiplying information by coefficients of the first estimated crosstalk cancellation matrix.

Method 600 can be applied for FEXT cancellation. Accordingly: (i) stage 610 can include generating an estimated FEXT cancellation matrix for the first frequency bin of the first group, (ii) stage 620 can include generating a second estimated FEXT cancellation matrix for the first frequency bin of the second group, (iii) Stage 630 can include cancelling FEXT for the first frequency bin of the first group by utilizing the first estimated FEXT cancellation matrix, (iv) stage 640 can include calculating additional FEXT cancellation coefficients based on the first and second estimated FEXT cancellation matrices, (v) stage 650 can include cancelling FEXT for at least one other frequency bin of the first group that differ from the first frequency bin of the first group by utilizing the additional FEXT cancellation coefficients, and (vi) stage 660 can include cancelling FEXT for at least one other frequency bin of the second group that differs from the first frequency bin of the second group by utilizing the additional FEXT cancellation coefficients. This other frequency bin can precede the first frequency bin of the second group.

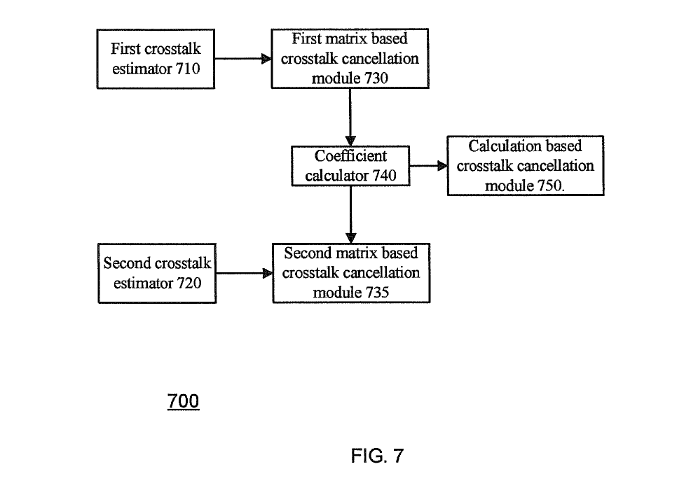

FIG. 7 illustrates system 700 according to an embodiment of the invention. System 700 includes first crosstalk estimator 710, second crosstalk estimator 720, first matrix based crosstalk cancellation module 730, second matrix based crosstalk cancellation module 735, coefficient calculator 740 and calculation based crosstalk cancellation module 750.

First crosstalk estimator 710 is for generating a first estimated crosstalk cancellation matrix for a first frequency bin of a first group of adjacent frequency bins. The first estimated crosstalk cancellation matrix provides an estimation of a crosstalk cancellation that is expected to mitigate crosstalk that is generated at the first frequency bin of the first group by an array of transmitters that transmit information over different copper pairs that form a bonded digital subscriber line (DSL) link.

Second crosstalk estimator 720 is for generating a second estimated crosstalk cancellation matrix for a first frequency bin of a second group of adjacent frequency bins. The second estimated crosstalk cancellation matrix provides an estimation of a crosstalk cancellation that is expected to mitigate crosstalk that is generated at the first frequency bin of the second group by the array of transmitters.

The matrix based crosstalk cancellation module 730 can be configured to cancel crosstalk for the first frequency bin of the first group by retrieving the first estimated crosstalk cancellation matrix from a memory module and multiplying information by coefficients of the first estimated crosstalk cancellation matrix.

First matrix based crosstalk cancellation module 730 is for cancelling crosstalk for the first frequency bin of the first group by utilizing the first estimated crosstalk cancellation matrix.

Second matrix based crosstalk cancellation module 735 is for cancelling crosstalk for the first frequency bin of the second group by utilizing the second estimated crosstalk cancellation matrix.

Coefficient calculator 740 is for calculating additional crosstalk coefficients based on the first and second estimated crosstalk cancellation matrices.

Calculation based crosstalk cancellation module 750 is for cancelling crosstalk for at least one other frequency bin of the first group that differs from the first frequency bin of the first group by utilizing the additional crosstalk coefficients.

The calculation based crosstalk cancellation module 750 can be configured to cancel crosstalk for at least one other frequency bin of the second group that differ from the first frequency bin of the second group by utilizing the additional crosstalk coefficients.

The first crosstalk estimator 710 can be configured to generate a first estimated far end crosstalk (FEXT) cancellation matrix for the first frequency bin of the first group. The second crosstalk estimator 720 can be configured to generate a second estimated FEXT cancellation matrix for the first frequency bin of the second group.

The matrix based crosstalk cancellation module 730 can be configured to cancel FEXT for the first frequency bin of the first group by utilizing the first estimated FEXT cancellation matrix.

The coefficient calculator 740 can be configured to calculate additional FEXT cancellation coefficients based on the first and second estimated FEXT cancellation matrices.

The calculation based crosstalk cancellation module 750 can be configured to cancel FEXT for at least one other frequency bin of the first group that differ from the first frequency bin of the first group by utilizing the additional FEXT cancellation coefficients.

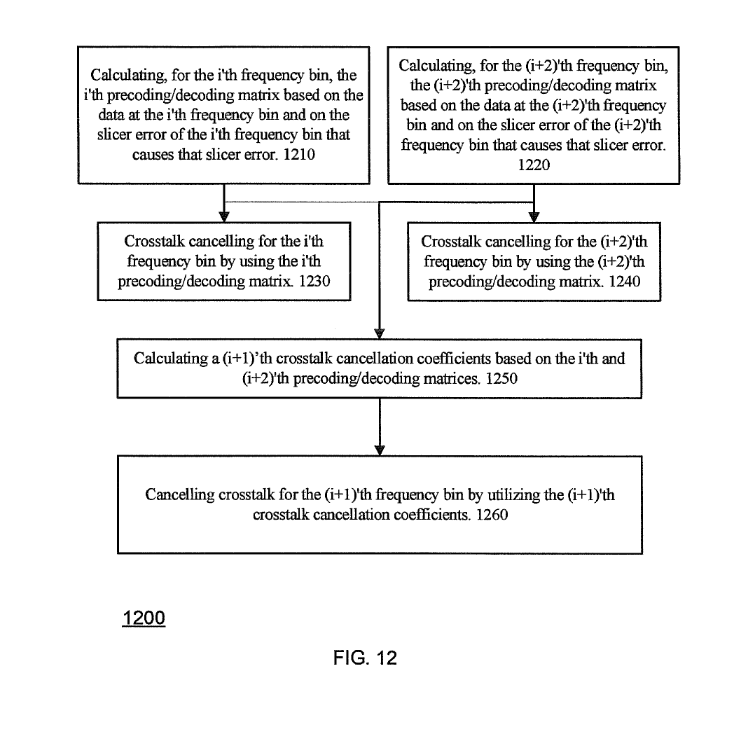

FIG. 12 illustrates method 1200 for crosstalk cancellation according to an embodiment of the invention.

It is assumed that each group includes two frequency bins. These can be denoted as the i′th frequency bin and the (i+2)′th frequency bin.

Method 1200 starts by stages 1210 and 1220.

Stage 1210 includes calculating, for the i′th frequency bin, the i′th pre-coding/decoding matrix based on the data at the i′th frequency bin and on the slicer error of the i′th frequency bin that causes that slicer error.

Stage 1220 includes calculating, for the (i+2)′th frequency bin, the (i+2)′th pre-coding/decoding matrix based on the data at the (i+2)′th frequency bin and on the slicer error of the (i+2)′th frequency bin that causes that slicer error.

Stage 1210 is followed by stage 1230 of crosstalk cancelling for the i′th frequency bin by using the i′th pre-coding/decoding matrix

Stage 1220 is followed by stage 1240 of crosstalk cancelling for the (i+2)′th frequency bin by using the (i+2)′th pre-coding/decoding matrix

Stages 1210 and 1220 are also followed by stage 1250 of calculating (i+l)th crosstalk cancellation coefficients based on the i′th and (i+2)′th pre-coding/decoding matrices.

Stage 1250 is followed by stage 1260 of cancelling crosstalk for the (i+1)′th frequency bin (that belongs to the group of frequency bins of the i′th frequency bins) by utilizing the (i+1)′th crosstalk cancellation coefficients.

Simulation Results

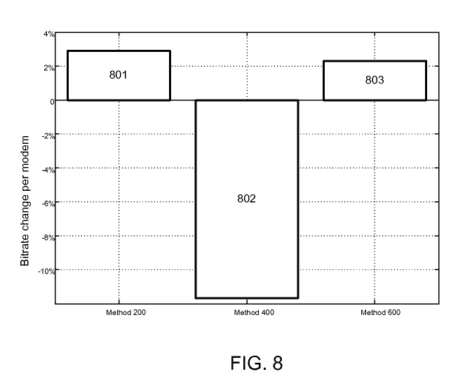

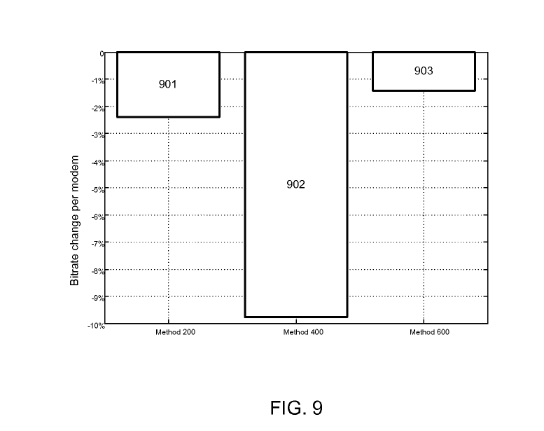

FIG. 8 and FIG. 9 show an example of the performance of methods 200, 400 and 600 when applied to VDSL2 FEXT cancellation with a group size of n=16 bins.

In this case, the loop length used is 400m, and the average throughput per modem was 50 Mbps downstream and 25 Mbps upstream.

The upstream and downstream bitrates achieved with each of the three methods (200, 400 and 600) described above are compared to the upstream and downstream bitrates achieved without any memory optimization, namely by estimating, adapting, and using the pre-coding/decoding coefficients separately for each frequency bin.

The results of FIG. 8 and FIG. 9 show that method 200 and method 600 result in relatively small changes in achievable performance, while allowing a very significant reduction in memory size by a factor of 16.

Selective Storage of Coefficients

According to an embodiment of the invention a diagonal of a crosstalk estimation matrix (such as a pre-coding/decoding matrix) includes coefficients that represent a self-crosstalk—the affect of a transmitter of the j′th modem of a transmitting array on the receiver of the j′th modem of a receiving array. These coefficients are either known in advance or are normalized to a known number (such as 1). According to an embodiment of the invention crosstalk estimation matrices are stored in memory modules without their diagonal coefficients—thus saving storage space and saving accesses to the memory. Alternatively—these diagonal coefficients are stored but not retrieved.

The selective storage can be implemented in addition to any of the mentioned above methods. It can be applied on the estimated crosstalk cancellation matrices, on the group crosstalk cancellation matrices or both.

Reduction of the Size of Coefficients

According to an embodiment of the invention coefficients of the crosstalk cancellation matrices can store compressed coefficients. The coefficients (for example decoding/pre-coding coefficients) can be decompressed (on the fly) after retrieval and used in their decompressed format.

Thus, coefficients are computed using the maximum possible number of bits, but will be stored using fewer bits. The reduction in the number of bits can be performed various manners such as: (i) discarding Least Significant Bits—resulting in lower accuracy of the pre-coding/decoding computations; (ii) discarding MSB Most Significant Bits—in this case, when the coefficients are read from memory they have to be resealed so that they are restored to the right magnitude before being multiplied with the transmitted data for the pre-coding operation or with the received data for the decoding operation. This resealing should be performed so that it does not result in excessive clipping.

The reduction of size of coefficients can be implemented in addition to any of the mentioned above methods. It can be applied on the estimated crosstalk cancellation matrices, on the group crosstalk cancellation matrices or both.

Either one of crosstalk module 50 of FIG. 1, system 500 of FIG. 5, system 700 of FIG. 7 includes at least one physical component. Either one of method 200 of FIG. 2, 300 of FIG. 3, method 400 of FIG. 4, method 600 of FIG. 6, method 1000 of FIG. 10, method 1100 of FIG. 11 and method 1200 FIG. 12 is executed by a system or module that includes at least one hardware component. At least one stage of each of these mentioned above methods is executed by a hardware component.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for crosstalk cancellation, the method comprises:
generating estimated crosstalk cancellation matrices for each frequency bin of a group of adjacent frequency bins, wherein each estimated crosstalk cancellation matrix provides an estimation of a crosstalk cancellation that is expected to mitigate crosstalk that is generated at a single frequency bin by an array of transmitters that transmit information over different copper pairs that form a bonded digital subscriber line link;
generating a group crosstalk cancellation matrix based on the estimated crosstalk cancellation matrices, wherein a size of the group crosstalk cancellation matrix is smaller that an aggregate size of the estimated crosstalk cancellation matrices; and
cancelling crosstalk for each frequency bin of the group by utilizing the group crosstalk cancellation matrix.

2. The method according to claim 1, comprising:
generating estimated far end crosstalk (FEXT) cancellation matrices for each frequency bin of the group;
generating a group FEXT cancellation matrix based on the estimated FEXT cancellation matrices; and
cancelling FEXT for each frequency bin of the group by utilizing the group FEXT cancellation matrix.

3. The method according to claim 1, comprising:
generating an estimated crosstalk cancellation matrix for each frequency bin of each group out of multiple groups of adjacent frequency bins;
generating, for each group, a group crosstalk cancellation matrix based on the estimated crosstalk cancellation matrices of the group; and
cancelling crosstalk for each frequency bin of each group by utilizing a group crosstalk cancellation matrix of the group.

4. The method according to claim 3 wherein at least two groups comprise a same number of frequency bins.

5. The method according to claim 3 wherein at least two different groups comprise a different number of frequency bins.

6. The method according to claim 1 comprising:
storing the group crosstalk cancellation matrix at a second memory module; and
performing only a single retrieval of each coefficient of the group crosstalk cancellation matrix while cancelling crosstalk for each frequency bin of the group.

7. The method according to claim 1, comprising generating the group crosstalk cancellation matrix by averaging the estimated crosstalk cancellation matrices.

8. The method according to claim 1, comprising generating the group crosstalk cancellation matrix by interpolating the estimated crosstalk cancellation matrices.

9. The method according to claim 1, comprising:
generating estimated crosstalk cancellation matrices that are pre-coding matrices;
generating a group crosstalk cancellation matrix that is a group pre-coding matrix;
cancelling crosstalk, by utilizing the group pre-coding matrix, for each frequency bin of the group by pre-coding information to provide pre-coded information; and
transmitting the pre-coded information.

10. A method for crosstalk cancellation, the method comprises:
generating an estimated crosstalk cancellation matrix for a single frequency bin out of a group of adjacent frequency bins, wherein the estimated crosstalk cancellation matrix provides an estimation of a crosstalk cancellation that is expected to mitigate crosstalk that is generated at the single frequency bin by an array of transmitters that transmit information over different copper pairs that form a bonded digital subscriber line (DSL) link; and
cancelling crosstalk for each frequency bin of the group by utilizing the estimated crosstalk cancellation matrix.

11. The method according to claim 10, comprising:
generating an estimated far end crosstalk (FEXT) cancellation matrix for the single frequency bin of the group; and
cancelling FEXT for each frequency bin of the group by utilizing the estimated FEXT cancellation matrix.

12. The method according to claim 10, comprising:
generating, for each group out of multiple groups of adjacent frequency bins, an estimated crosstalk cancellation matrix; and
cancelling crosstalk for each frequency bin of each group by utilizing an estimated crosstalk cancellation matrix of the group.

13. A method for crosstalk cancellation, the method comprises:
generating a first estimated crosstalk cancellation matrix for a first frequency bin of a first group of adjacent frequency bins, wherein the first estimated crosstalk cancellation matrix provides an estimation of a crosstalk cancellation that is expected to mitigate crosstalk that is generated at the first frequency bin of the first group by an array of transmitters that transmit information over different copper pairs that form a bonded digital subscriber line (DSL) link;
generating a second estimated crosstalk cancellation matrix for a first frequency bin of a second group of adjacent frequency bins, wherein the second estimated crosstalk cancellation matrix provides an estimation of a crosstalk cancellation that is expected to mitigate crosstalk that is generated at the first frequency bin of the second group by the array of transmitters;
cancelling crosstalk for the first frequency bin of the first group by utilizing the first estimated crosstalk cancellation matrix;
calculating additional crosstalk coefficients based on the first and second estimated crosstalk cancellation matrices; and
cancelling crosstalk for at least one other frequency bin of the first group that differs from the first frequency bin of the first group, by utilizing the additional crosstalk coefficients.

14. The method according to claim 13, comprising cancelling crosstalk for at least one other frequency bin of the second group that differs from the first frequency bin of the second group by utilizing the additional crosstalk coefficients.

15. The method according to claim 13, comprising cancelling crosstalk for the first frequency bin of the first group by retrieving the first estimated crosstalk cancellation matrix from a memory module and multiplying information by coefficients of the first estimated crosstalk cancellation matrix.

16. The method according to claim 13, comprising:
generating an estimated first far end crosstalk (FEXT) cancellation matrix for the first frequency bin of the first group;
generating a second estimated FEXT cancellation matrix for the first frequency bin of the second group;
cancelling FEXT for the first frequency bin of the first group by utilizing the first estimated FEXT cancellation matrix;
calculating additional FEXT cancellation coefficients based on the first and second estimated FEXT cancellation matrices; and
cancelling FEXT for at least one other frequency bin of the first group that differ from the first frequency bin of the first group by utilizing the additional FEXT cancellation coefficients.

17. A system for crosstalk cancellation, the system comprises:
a crosstalk estimator, for generating estimated crosstalk cancellation matrices for each frequency bin of a group of adjacent frequency bins; wherein each estimated crosstalk cancellation matrix provides an estimation of a crosstalk cancellation that is expected to mitigate crosstalk that is generated at a single frequency bin by an array of transmitters that transmit information over different copper pairs that form a bonded digital subscriber line (DSL) link;
a generator, for generating a group crosstalk cancellation matrix based on the estimated crosstalk cancellation matrices, wherein a size of the group crosstalk cancellation matrix is smaller that an aggregate size of the estimated crosstalk cancellation matrices; and
a crosstalk cancellation module for cancelling crosstalk for each frequency bin of the group by utilizing the group crosstalk cancellation matrix.

18. The system according to claim 17, wherein the crosstalk estimator is for generating an estimated far end crosstalk (FEXT) cancellation matrices for each frequency bin of the group;
wherein the generator is for generating a group FEXT cancellation matrix based on the Estimated FEXT cancellation matrices; and
wherein the crosstalk cancellation module is for cancelling FEXT for each frequency bin of the group by utilizing the group FEXT cancellation matrix.

19. The system according to claim 1, wherein the crosstalk estimator is for generating an estimated crosstalk cancellation matrix for each frequency bin of each group out of multiple groups of adjacent frequency bins;
wherein the generator is for generating, for each group, a group crosstalk cancellation matrix based on the estimated crosstalk cancellation matrices; and
wherein the crosstalk cancellation module is for cancelling crosstalk for each frequency bin of each group by utilizing a group crosstalk cancellation matrix associated with the group.

20. The system according to claim 19 wherein at least two groups comprise a same number of frequency bins.

21. The system according to claim 19 wherein at least two different groups comprise a different number of frequency bins.

22. The system according to claim 17 comprising:
a first memory module for storing the estimated crosstalk cancellation matrices; and
a second memory module for storing the group crosstalk cancellation matrix;
wherein the crosstalk cancellation module is configured to perform only a single retrieval of each coefficient of the group crosstalk cancellation matrix from the second memory module during a cancellation of crosstalk for each frequency bin of the group.

23. The system according to claim 17, wherein the generator is configured to generate the group crosstalk cancellation matrix by averaging the estimated crosstalk cancellation matrices.

24. The system according to claim 17, wherein the generator is configured to generate the group crosstalk cancellation matrix by interpolating the estimated crosstalk cancellation matrices.

25. The system according to claim 1, wherein the crosstalk estimator is for generating estimated crosstalk cancellation matrices, the estimated crosstalk estimation matrices are pre-coding matrices;
wherein the generator is for generating a group crosstalk cancellation matrix, the group crosstalk cancellation matrix is a group pre-coding matrix;
wherein the crosstalk cancellation module is for cancelling crosstalk for each frequency bin of the group by pre-coding information while utilizing the group pre-coding matrix to provide pre-coded information; and
wherein the system comprises the first group of modems, the first group of modems is configured to transmit the pre-coded information.

26. A system for crosstalk cancellation, the system comprises:
a crosstalk estimator for generating an estimated crosstalk cancellation matrix for a single frequency bin out of a group of adjacent frequency bins; wherein the estimated crosstalk cancellation matrix provides an estimation of a crosstalk cancellation that is expected to mitigate crosstalk that is generated at the single frequency bin by an array of transmitters that transmit information over different copper pairs that form a bonded digital subscriber line (DSL) link; and
a crosstalk cancellation module for cancelling crosstalk for each frequency bin of the group by utilizing the estimated crosstalk cancellation matrix.

27. The system according to claim 26, wherein the crosstalk estimator is for generating an estimated far end crosstalk (FEXT) cancellation matrix for the single frequency bin of the group; and wherein the crosstalk cancellation module is for cancelling FEXT for each frequency bin of the group by utilizing the Estimated FEXT cancellation matrix.

28. The system according to claim 26, wherein the crosstalk estimator is for generating, for each group out of multiple groups of adjacent frequency bins, an estimated crosstalk cancellation matrix; and
wherein the crosstalk cancellation module is for cancelling crosstalk for each frequency bin of each group by utilizing an estimated crosstalk cancellation matrix that is associated with the group.

29. A system for crosstalk cancellation, the system comprising:
a first crosstalk estimator for generating a first estimated crosstalk cancellation matrix for a first frequency bin of a first group of adjacent frequency bins; wherein the first estimated crosstalk cancellation matrix provides an estimation of a crosstalk cancellation that is expected to mitigate crosstalk that is generated at the first frequency bin of the first group by an array of transmitters that transmit information over different copper pairs that form a bonded digital subscriber line (DSL) link;
a second crosstalk estimator for generating a second estimated crosstalk cancellation matrix for a first frequency bin of a second group of adjacent frequency bins; wherein the second estimated crosstalk cancellation matrix provides an estimation of a crosstalk cancellation that is expected to mitigate crosstalk that is generated at the first frequency bin of the second group by the array of transmitters;
a matrix based crosstalk cancellation module for cancelling crosstalk for the first frequency bin of the first group by utilizing the first estimated crosstalk cancellation matrix;
a coefficient calculator for calculating additional crosstalk coefficients based on the first and second estimated crosstalk cancellation matrices; and
a calculation-based crosstalk cancellation module for cancelling crosstalk for at least one other frequency bin of the first group that differ from the first frequency bin of the first group by utilizing the additional crosstalk coefficients.

30. The system according to claim 29, wherein the calculation based crosstalk cancellation module is for cancelling crosstalk for at least one other frequency bin of the second group that differ from the first frequency bin of the second group by utilizing the additional crosstalk coefficients.

31. The system according to claim 29, wherein the matrix based crosstalk cancellation module is for cancelling crosstalk for the first frequency bin of the first group by retrieving the first estimated crosstalk cancellation matrix from a memory module and multiplying information by coefficients of the first estimated crosstalk cancellation matrix.

32. The system according to claim 29, wherein the first crosstalk estimator is for generating a first estimated far end crosstalk (FEXT) cancellation matrix for the first frequency bin of the first group;
wherein the second crosstalk estimator is for generating a second Estimated FEXT cancellation matrix for the first frequency bin of the second group;
wherein the matrix based crosstalk cancellation module is for cancelling FEXT for the first frequency bin of the first group by utilizing the first Estimated FEXT cancellation matrix;
wherein the coefficient calculator is for calculating additional FEXT cancellation coefficients based on the first and second Estimated FEXT cancellation matrices; and the calculation based crosstalk cancellation module is for cancelling FEXT for at least one other frequency bin of the first group that differ from the first frequency bin of the first group by utilizing the additional FEXT cancellation coefficients.

33. The system according to claim 1, wherein the crosstalk estimator is for generating estimated crosstalk cancellation matrices, the estimated crosstalk estimation matrices are decoding matrices;
wherein the generator is for generating a group crosstalk cancellation matrix, the group crosstalk cancellation matrix is a group decoding matrix; and
wherein the crosstalk cancellation module is for cancelling crosstalk for each frequency bin of the group by decoding information while utilizing the group decoding matrix to provide decoded information.
